(19) United States
(12) Patent Application Publication
(10) Pub. No.: US 2026/0110571 A1
(43) Pub. Date: Apr. 23, 2026

(54) Multi-Event Distributed Forwarding Sensing with Dual-Sensor Adaptive Beamforming

(71) Applicant: NEC Laboratories America, Inc., Princeton, NJ (US)

(72) Inventors: Jian Fang, Princeton, NJ (US); Ting Wang, West Windsor, NJ (US)

(73) Assignee: NEC Laboratories America, Inc., Princeton, NJ (US)

(21) Appl. No.: 19/360,712

(22) Filed: Oct. 16, 2025

Related U.S. Application Data
(60) Provisional application No. 63/708,318, filed on Oct. 17, 2024.

(51) Int. Cl. G01H 9/00; H04R 23/00

(52) U.S. Cl. CPC G01H 9/004; H04R 23/008; H04R 2430/25

(57) ABSTRACT

A distributed forwarding sensing system and method for multi-event localization and high-fidelity acoustic waveform reconstruction in which the method includes modeling a bi-directional distributed forwarding sensing scheme as an equivalent dual-element sensor array (SA2), where an event location (z) along a fiber is mapped to a direction-of-arrival (DOA) angle (α). Signals from first and second receivers are transformed into the time-frequency domain. Generalized Cross-Correlation with Phase Transform (GCC-PHAT) is used to accurately localize multiple simultaneous events by estimating a time shift (Δτ). An adaptive beamforming technique, such as a Generalized Sidelobe Canceller (GSC), is then steered toward the desired event location to enhance the acoustic signal and mitigate noise and interference from other locations along the fiber, resulting in a high-fidelity reconstructed acoustic waveform suitable for machine learning classification.

### CROSS REFERENCE TO RELATED APPLICATIONS

This application claims the benefit of U.S. Provisional Patent Application Ser. No. 63/708,318 filed Oct. 17, 2024, the entire contents of which is incorporated by reference as if set forth at length herein.

### FIELD OF THE INVENTION

This application relates generally to optical sensing. More particularly, it pertains to multi-event distributed forwarding sensing with dual-sensor adaptive beamforming.

### BACKGROUND OF THE INVENTION

Recently, distributed forwarding sensing has been an emerging topic in the distributed sensing field. As is known by those skilled in the art, the forward sensing method provides many advantages as compared with a traditional backscatter-based sensing approach, such as higher signal-to-noise ratio (SNR), broader bandwidth, longer sensing range, ability to passthrough amplifiers, and compatibility with next-gen hollow-core fibers.

Notwithstanding these recognized advantages, existing forwarding sensing approaches experience certain critical challenges. First, a phase change or vibration signal is integrated over an entire optical fiber, making it difficult to separate a desired signal from any noise.

Second, it is difficult to localize multiple events at various locations simultaneously. When multiple events occur simultaneously, phase changes of these events composite together and as a result are difficult to separate from one another. Moreover, a phase change signal at a particular location is difficult to recover with high fidelity, which makes it difficult to classify by an artificial intelligence (AI) or machine learning (ML) model.

### SUMMARY OF THE INVENTION

An advance in the art is made according to aspects of the present disclosure directed to a novel forward sending technique.

In sharp contrast to the prior art that only detect an integral of all signals along a length of an optical fiber, our inventive forward sending technique employs a dual sensor array model which operates like bi-directional distributed forwarding sensing. As a result, bottlenecks in forwarding sensing are solved by utilizing array processing and an adaptive beamforming technique using a generalized sidelobe canceller such that a particular optical fiber location may be monitored, while exhibiting enhanced acoustic signal reconstruction and reduced noise and interference from other optical fiber locations.

As we shall show and describe, our inventive techniques include: i) an equivalent dual-element sensor array (SA2) model of the forwarding sensing; ii) Generalized Cross-Correlation with the Phase Transform (GCC-PHAT) method to find a location of multiple acoustic events simultaneously; and iii) adaptive beamforming to focus on a particular optical fiber location, enhance acoustic wave reconstruction and reduce interference.

### BRIEF DESCRIPTION OF THE DRAWING

FIG. 1 is a schematic flow diagram showing our illustrative method according to aspects of the present disclosure as compared with conventional distributed forwarding sensing.

FIG. 2 is a schematic diagram showing illustrative principle of forward sensing according to aspects of the present disclosure.

FIG. 3 is a schematic diagram showing an illustrative principle of equivalent dual-sensor model (SA2) of the bi-directional forwarding sensing according to aspects of the present disclosure.

FIG. 4 is a schematic diagram showing illustrative processing steps in method according to aspects of the present invention.

FIG. 5 is a schematic diagram showing illustrative processing steps of advanced array processing of Rx optical pulses for method according to aspects of the present disclosure.

FIG. 6 is a schematic diagram showing illustrative experimental setup in which NLL: narrow linewidth laser; OC: Optical Coupler; ICR: integrated coherent receiver; EDFA: erbium-doped fiber amplifier; AOM: acousto-optic modulator; LPF: low-pass filter; BPF: band-pass filter; DSO: digital signal oscilloscope; according to aspects of the present disclosure.

FIG. 7 is a schematic diagram showing an illustrative configuration of sensing fiber and its equivalent SA2 model; FS: fiber stretcher; according to aspects of the present invention.

FIG. 8 shows a series of plots indicative of original raw data applied to each of the fiber stretcher; according to aspects of the present invention.

FIG. 9 shows the experimental results of the fiber stretcher in which Step 1 is the optical phase of Rx1 and Rx2, Step 2 is the correlation spectrogram from GCC-PHAT and the estimated location according to aspects of the present invention.

FIG. 10 shows the reconstructed waveforms at each location using the adaptive generalized sidelobe canceller (GSC) beamforming according to aspects of the present invention.

FIG. 11 is a schematic diagram showing an illustrative computer system in which methods of the instant disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that optical forwarding sensing, or forward transmission distributed fiber-optic sensing, is a technique that uses a communication signal transmitted through an optical fiber to detect external disturbances. Unlike older backscatter methods, which rely on light bouncing back from disturbances, forward sensing analyzes how a continuous, forward-moving signal is affected. This technique advantageously allows simultaneous, long-distance data transmission and environmental monitoring using the same fiber.

This technology uses the optical fiber itself as a sensor, with a central interrogator device to interpret the signal.
i) A laser sends a continuous signal down the optical fiber in a forward direction.
ii) Physical disturbances, such as vibrations or temperature changes, cause minute phase shifts in the forward-traveling light wave.
iii) A coherent receiver at the end of the fiber detects these minute phase changes and converts them into electrical signals.
iv) Advanced digital signal processing (DSP) is used to interpret the phase shifts and pinpoint the exact location and nature of the disturbance.

This technology provides key advantages for sensing including the following.
i) Long-range monitoring: Forward sensing systems can monitor disturbances over hundreds of kilometers, a much greater distance than backscatter methods.
ii) High sensitivity: The system is highly sensitive to subtle changes, enabling the detection of small-scale disturbances like vibrations and temperature changes.
iii) Integrated function: It allows for the simultaneous use of a single fiber for both high-speed data transmission and distributed sensing, a concept known as Integrated Sensing and Communication (ISAC).
iv) Lower hardware cost: The ability to use existing optical communication infrastructure makes it a simplified and more cost-effective solution for adding sensing capabilities.

Optical forwarding sensing is ideal for monitoring long, linear infrastructure in real-time.
i) Pipeline monitoring: Detecting third-party interference, leaks, or mechanical deformation alongside oil and gas pipelines.
ii) Perimeter security: Creating a virtual “fence” to detect and localize intrusions along borders, railways, and other critical infrastructure.
iii) Urban structure monitoring: Monitoring the structural health of bridges, tunnels, and dams.
iv) Environmental and seismic monitoring: Detecting seismic waves or temperature changes, including submarine fiber optic cables.

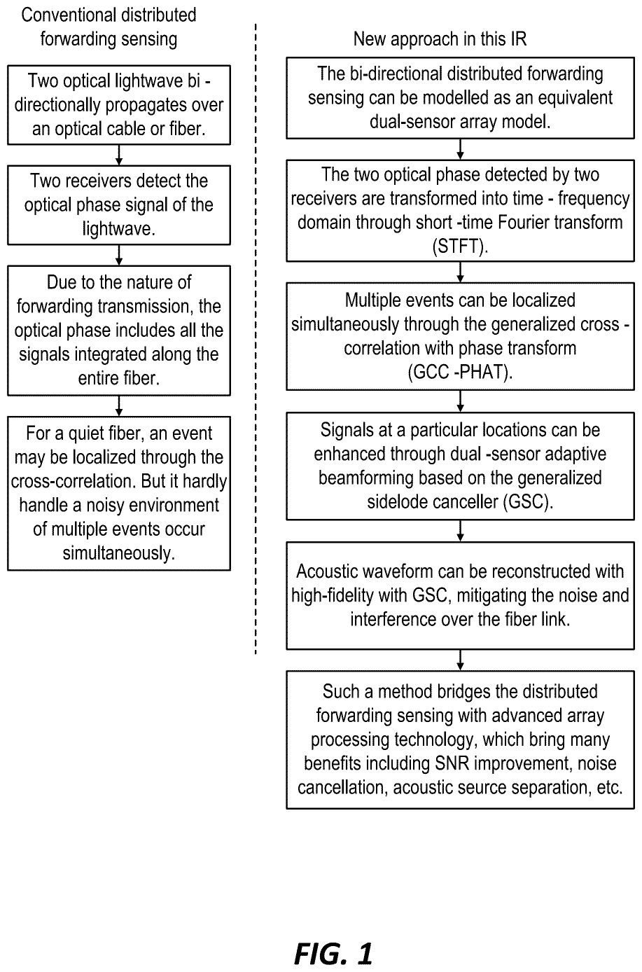

FIG. 1 is a schematic flow diagram showing our illustrative method according to aspects of the present disclosure as compared with conventional distributed forwarding sensing.

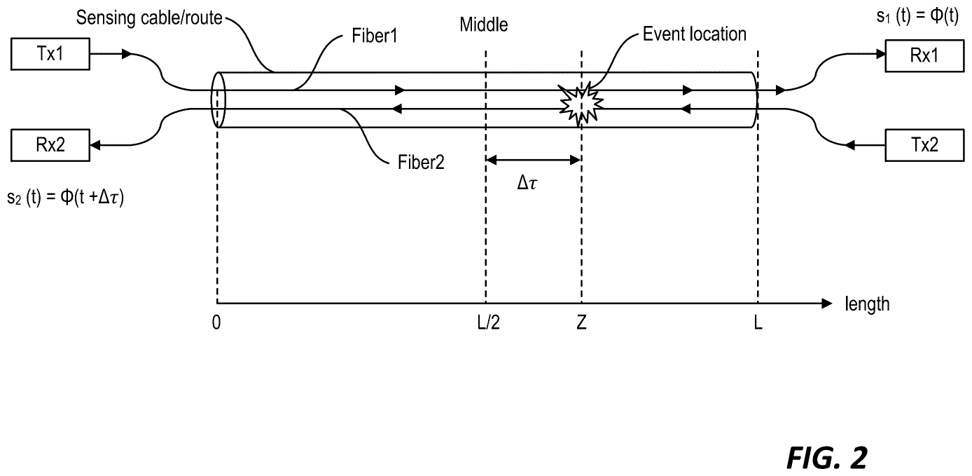

FIG. 2 is a schematic diagram showing illustrative principle of forward sensing according to aspects of the present disclosure.

The principle of distributed forward fiber sensing schemes is based on the time delay of optical phase change between two optical paths in one cable or route. FIG. 2 illustrates the principle of a typical forward sensing scheme, including two pairs of transmitters (Tx) and receivers (Rx). It is noted that for single-direction transmission, two optical fibers in the same optical cable are usually required to localize the events. In the case that allows bidirectional transmission, single optical fiber core may be used, and two Txs can send the optical light in different wavelengths.

When an event signal happens at location z, it modulates the optical phase of both paths. Depending on the event location, the optical phases at two paths will have similar waveforms but with a relative time shift Δτ, i.e., s₁(t) at Rx1 and s₂ (t) at Rx2 as shown in FIG. 2.

Assuming that the sensing cable length is L, then after the event happens at location z, optical path difference of fiber 1 and fiber 2 are L−2z, resulting in a relative time shift of

$$Δ τ = \frac{( L - 2 z ) {n}_{eff}}{{c}_{0}}$$

where n_{eff} denotes the effective refractive index of the fiber; c₀ is the speed of light in the vacuum.

The typical processing steps in distributed forwarding sensing are illustrated in FIG. 2, which contains two stages: the event localization stage and the waveform reconstruction stage. The optical phases from Rx signals are estimated via coherent detection. After that, two receivers are precisely synchronized through known overhead frames. In the localization stage, the time shift Δτ can be estimated through the cross-correlation of s₁(t) and s₂(t). Once Δτ is determined, then the event locations can be expressed as:

$$z = \frac{1}{2} ( L - \frac{c Δτ}{{n}_{eff}} ) .$$

In the reconstruction stage, the event signal can be reconstructed by time-shift the s₂(t) by −Δτ and sum with s₁(t) to improve the SNR.

When the sensing fiber is “quiet”, i.e., minimum noise or perturbations, a single event can be localized with the method described above. In practical, however, there are always other events and noises over the fiber route. For instance, when there are other events or noises n(t) occur at other locations, the forwarding sensing will integrate all these phase change along the path together. Therefore, cross-correlation will give multiple peaks which are hard to determine the real event of interest.

More importantly, the waveform of event at desired location needs to be recovered and reconstructed accurately, for event classification identification by a machine learning model. Unfortunately, most of the existing techniques for distributed forward sensing only focus on the localization instead of signal reconstruction.

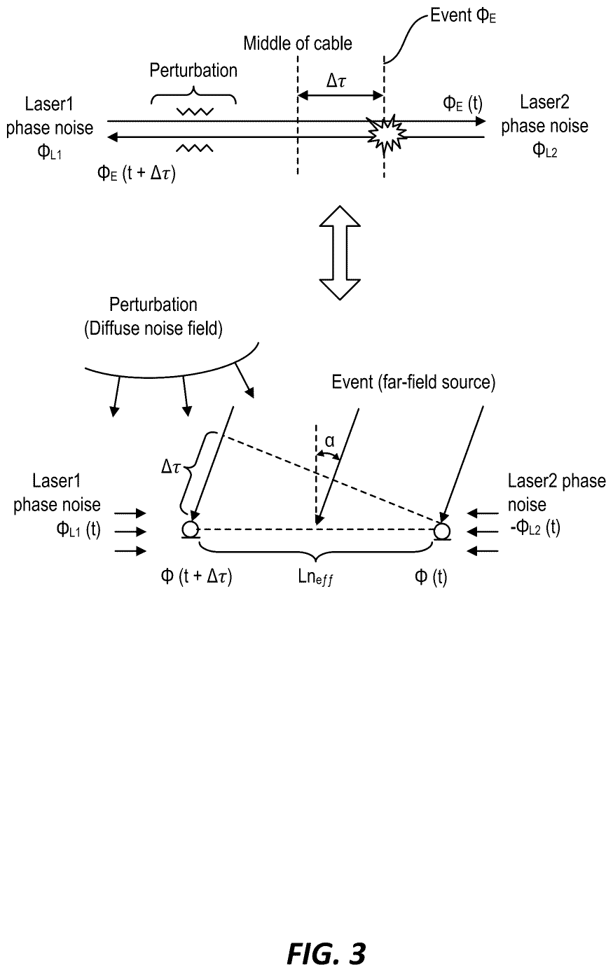

Accordingly, we have developed a novel method to solve this problem. First, we describe an equivalent model of dual-element sensor array (SA2) for the bi-directional forwarding sensing. We model the bi-directional forwarding sensing scheme as a SA2 model with a spacing of Ln_{eff}. Therefore, the vibration events occur along the sensing fiber can be treated as far-field acoustic events with incidence angle α, as shown in FIG. 3, which is a schematic diagram showing an illustrative principle of equivalent dual-sensor model (SA2) of the bi-directional forwarding sensing according to aspects of the present disclosure.

The relationship between the incidence angle α and fiber event location z can be obtained from the following relationship:

$$α = {sin}^{- 1} ( \frac{L - 2 z}{L} ) .$$

That means the location z in [0,L] can be mapped as a direction-of-arrival (DOA) angle α in

$$[ - \frac{π}{2} , \frac{π}{2} ] .$$

When multiple events or noises happen on different locations along the fiber, it is equivalent to different far-field sources incidents at different angles. Therefore, the reconstruction of vibration signal at location z becomes a beamforming task at angle α.

The external perturbation along the fiber can be modelled as the diffuse noise field in the SA2. The phase noise of the two lasers, i.e., φ_{L1} and φ_{L2}. can also model as two noise sources in the SA2 model. In the coherent detection, two laser light will beat with each other. Therefore, the phase noise term at sensor1 and sensor 2 can be expressed as φ_{L1} (t)−φ_{L2}(t+Δτ_{L}) and φ_{L1}(t+Δτ_{L})−φ_{L2}(t), where Δτ_{L}=Ln_{eff}/c₀. It equals two sources φ_{L1} and −φ_{L2} from left and right sides of the SA2, as shown in FIG. 3, which is a schematic diagram showing illustrative processing steps in method according to aspects of the present invention.

To effectively reconstruct the event signal, we utilize an adaptive beamforming technique for distributed forwarding sensing.

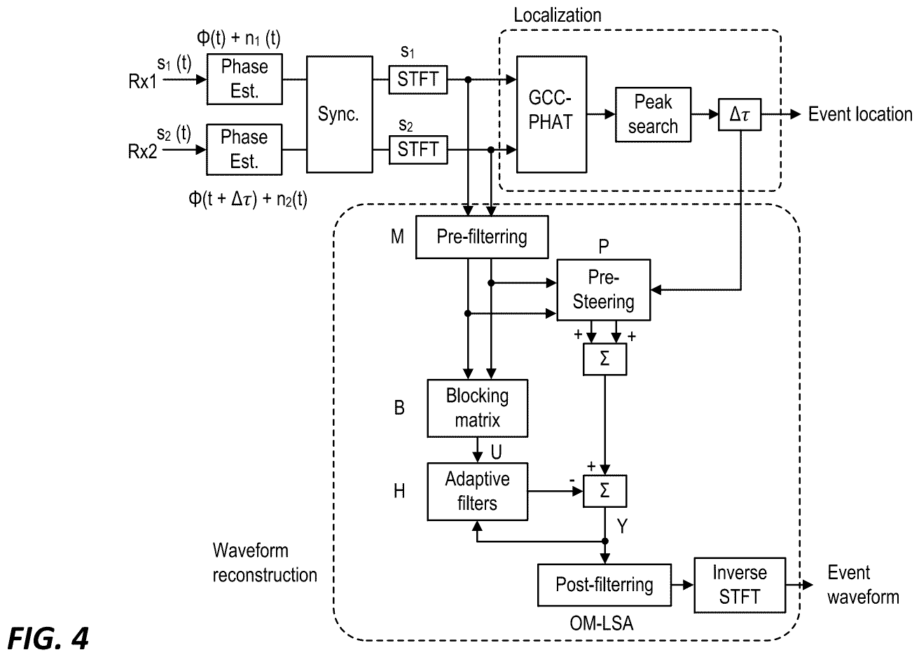

FIG. 4. shows the block diagram of the proposed event waveform reconstruction technique. Different from the conventional processing steps shown in FIG. 3, we transfer the two 1-D phase signals s₁(t) and s₂(t) into 2-D data blocks in time-frequency domain as S₁=[S₁(fₖ,tₗ)] and S₂=[S₂(fₖ,tₗ)], through the short-time Fourier transform (STFT) after the phase estimation and synchronization. In the localization stage, generalized cross-correlation with phase-transform (GCC-PHAT) is applied to each STFT frame pair to generate the correlation by emphasizing the phase information and normalizing the magnitude. Compared to the cross-correlation in conventional methods, GCC-PHAT reduces the impact of noises in complex environments, leading to more accurate time shift estimations.

In the waveform reconstruction stage, our method includes three steps: the pre-filtering, adaptive beamforming, and post-filtering. These steps are described in detail as follows.

### Pre-Filtering

The pre-filtering step selects the proper time-frequency patterns and removes the undesired parts. Especially, selecting some frequency components of interest and remove some frequency components which are unwanted. For instance, there are low-frequency signals (seismic wave) and high-frequency signals (acoustic noise, wind noise, etc.) in a real fiber route. So, the pre-filtering can remove the undesired frequency parts and separate the important parts.

Such a process can be expressed a masking filter M=[M(fₖ,tₗ)] to element-wise product (i.e., the Hadamard product) with both S₁ and S₂, resulting in two STFT matrices X₁=M⊙S₁, X₂=M⊙S₂, which ⊙ is the Hadamard product operator. The output of pre-filtering stage forms a Rx vector signal X=[X₁(fₖ,tₗ),X₂(fₖ,tₗ)]^{T}, which only contains necessary time and frequency components.

### Adaptive Beamforming

The adaptive beamforming step enhances the signals at desired location (or the steered location) and mitigates the stationary interference from other locations. Such a process is realized by constructing a linear constrained adaptive beamformer (such as a generalized sidelobe canceller, GSC), which comprises a pre-steering beamformer P, a blocking matrix B, an adaptive canceller H.

The pre-steering beamformer is responsible for steering the SA2 to the location of interest. According to the estimated delay Δτ from the GCC-PHAT step, the pre-steering beamformer applies the weight P=[e^{jπfΔτ},e^{-jπfΔτ}]^{T}/2 to the Rx signal vector X to combine them such that the system emphasize the signals at the desired location z=(L−cΔT/n_{eff})/2. The output of the pre-steering beamformer can be treated as the “delay-and-sun” operation.

The blocking matrix is used to remove the contribution of the desired signal at certain location while allowing the noise and interference to pass through. It creates a set of constraints to prevent the desired signal from influencing the adaptive filter in the next stage. The blocking matrix consists of weights that are orthogonal to the direction of the desired signal so that it “blocks” it while allowing other signals, like noise and interference, to pass through. For SA2 model, the blocking matrix typically is B=[e^{jπfΔτ},e^{-jπfΔτ}]^{T}/2. The output of the blocking matrix can be treated as the “delay-and-subtract” operation.

The adaptive canceller is responsible for adapting in real-time to the interference and noise that remains after the blocking matrix. It consists of adaptive weights that continuously adjust using an algorithm (often based on the least-mean-squares, LMS, or recursive least squares, RLS) to minimize the interference output. The adaptive canceller uses the output of the blocking matrix as a reference signal, adjusting the filter taps, minimizing the output power to cancel the interference in the direction of undesired signals. The target is to find an optimized H which minimize the sidelobes of GSC outputs.

### Post-Filtering

The adaptive beamforming can effectively remove the stationary noise but not effective to the transient interference. To solve that issue, post-filtering technique is added after the adaptive beamforming step to remove the transient noise.

We now note that the principle of distributed forward fiber sensing schemes is based on the time delay of optical phase change between two optical paths in one cable or route. FIG. 2 and FIG. 3 illustrate the principle of a typical forward sensing scheme, including two pairs of transmitters (Tx) and receivers (Rx). When an event signal happens at location zz, it modulates the optical phase of both paths. Depending on the event location, the optical phases at two paths will have similar waveforms but with a relative time shift Δτ, which can be expressed as Δτ=(L−2z)/c_{f}, where L and c_{f} denote the total fiber length, and the speed of light in the fiber, respectively. Once the Δτ is determined via the cross-correlation, the event location can also be calculated via z=(L−c_{f}Δτ)/2.

When the fiber is quiet, a single event is easily caught by the traditional method. However, it is difficult to handle multiple events with the presence of noise and interference. To solve this problem, we proposed an equivalent model of dual-sensor array (SA2). The bi-directional forwarding sensing with coherent detection can be modelled as a SA2 model with a spacing of L. Therefore, the vibration events occurs along the fiber can be treated as far-field acoustic events with incidence angle α=sin⁻¹((L−2z)/L), indicating that any location z∈[0,L] along the fiber can be mapped to a directional-of-arrival (DOA) angle α∈[−π/2,π/2,].

The external perturbation along the fiber can be modelled as the diffuse noise field in the SA2 The phase noise of the two lasers can also be modelled as two noise sources in the SA2 model. In the coherent detection, two laser light will beat with each other. Therefore, the phase noise term at sensor1 and sensor 2 can be expressed as two far-field sources from left and right sides of the SA2, as shown in FIG. 3.

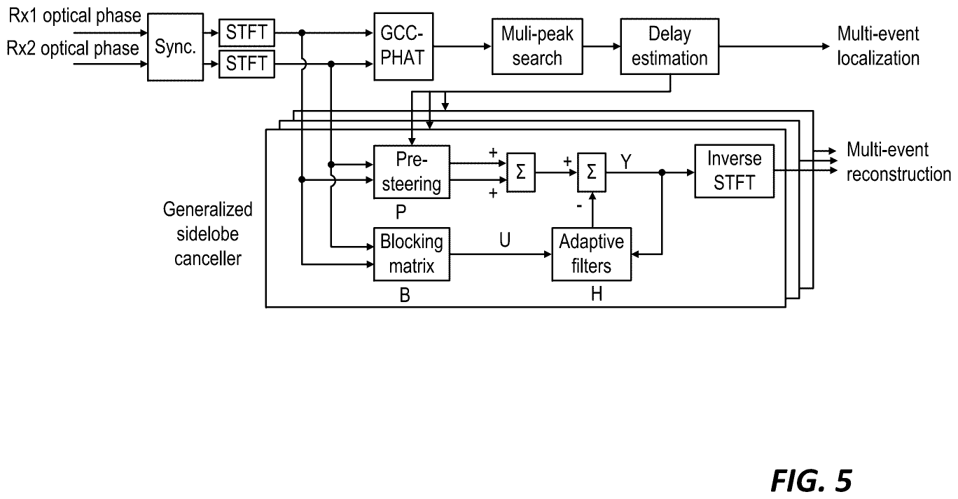

To effectively reconstruct the event signal, we utilize an adaptive beamforming technique as shown in FIG. 5. After synchronization, two optical phases from Rx are transferred into time-frequency domain through short-time Fourier transform (STFT). In the localization stage, generalized cross-correlation with phase-transform (GCC-PHAT) is applied to each STFT frame pair to generate the cross-correlation spectrograms for delay estimation and event location. In the waveform reconstruction stage, our method includes an adaptive beamformer, i.e. the generalized sidelobe canceller (GSC), which comprised a pre-steering beamformer P, a blocking matrix B, an adaptive canceller H. The pre-steering beamformer is responsible for steering the SA2 to the location of interest. The blocking matrix is used to remove the contribution of the desired signal at certain location while allowing the noise and interference to pass through. It creates a set of constraints to prevent the desired signal from influencing the adaptive filter in the next stage. The adaptive canceller uses the output of the blocking matrix as a reference signal, adjusting the filter taps, minimizing the output power to cancel the interference in the direction of undesired signals.

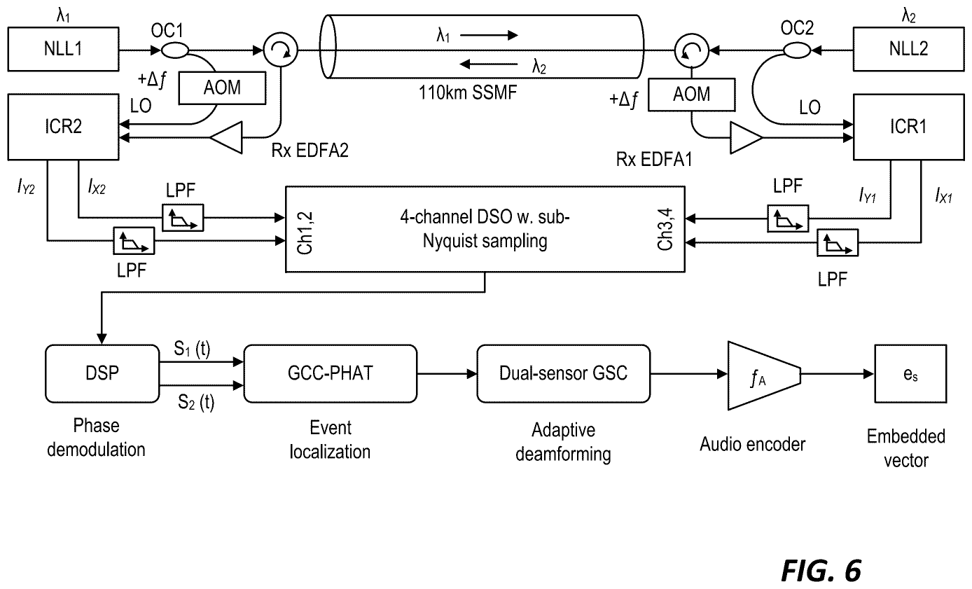

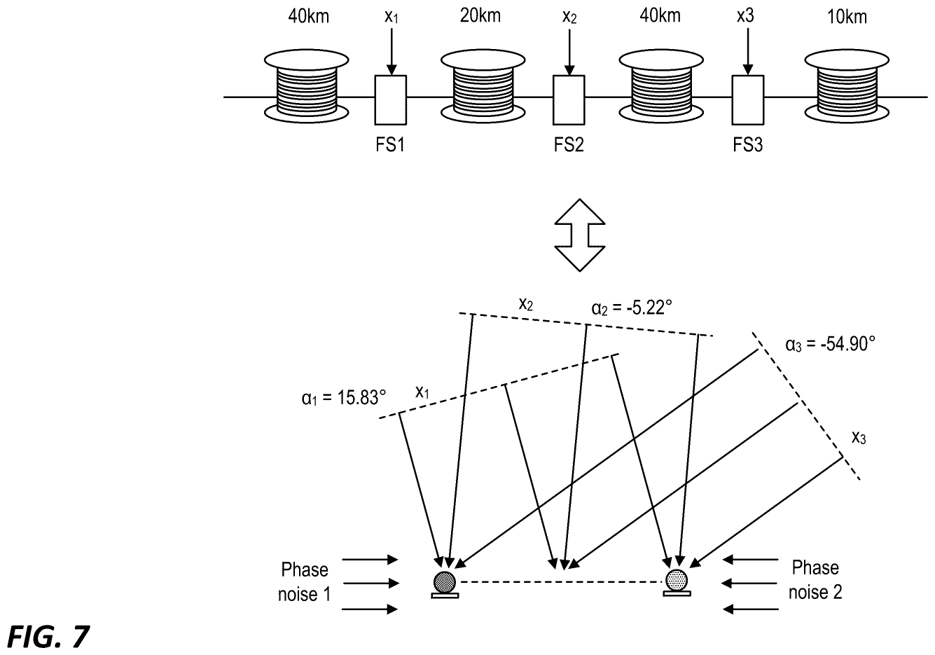

FIG. 6 shows the experimental setup. FIG. 7 shows the configuration of sensing and its equivalent SA2 model. Two NLLs (NKT, 100 Hz linewidth) are used as light sources. The wavelength of two NLLs are carefully adjusted to a frequency spacing around 400 MHz. Two AOMs (G&H, 200 MHz) shift the wavelength by 200 MHz. The output of ICRs are collected by a 4-ch DSO with sub-Nyquist sampling at 62.5 MHz. The length of sensing fiber is ˜110 km, consisting of three PZT fiber stretcher inserted among 4 SSMF spools (40 km, 20 km, 40 km and 10 km). According to our SA2 model, this equals to three far-field sources emitting from angles 15.83°, −5.22° and −54.9°, respectively. The light power injected into the fiber is set to <1 mW to avoid nonlinearities

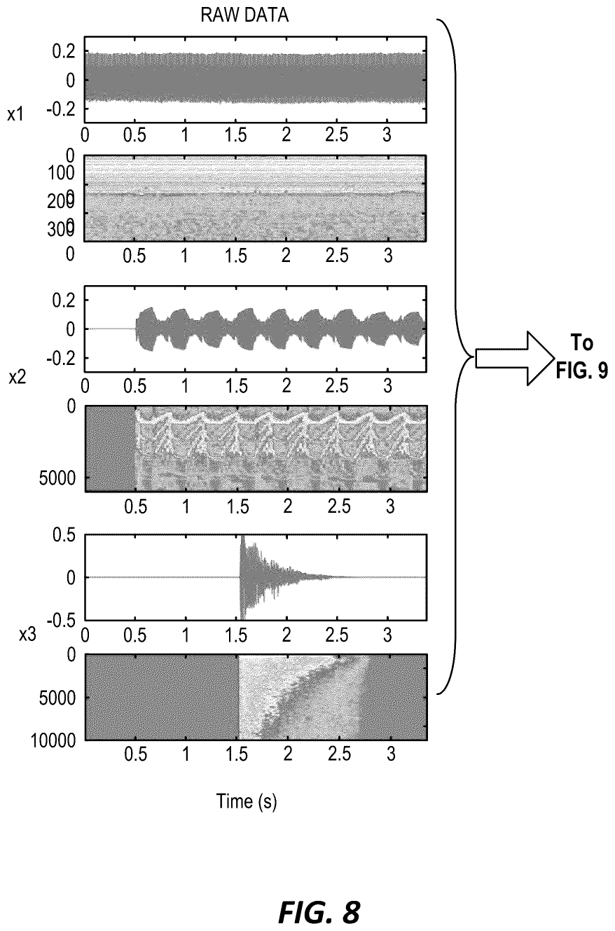

FIG. 8 shows a series of plots indicative of original raw data applied to each of the fiber stretcher; according to aspects of the present invention.

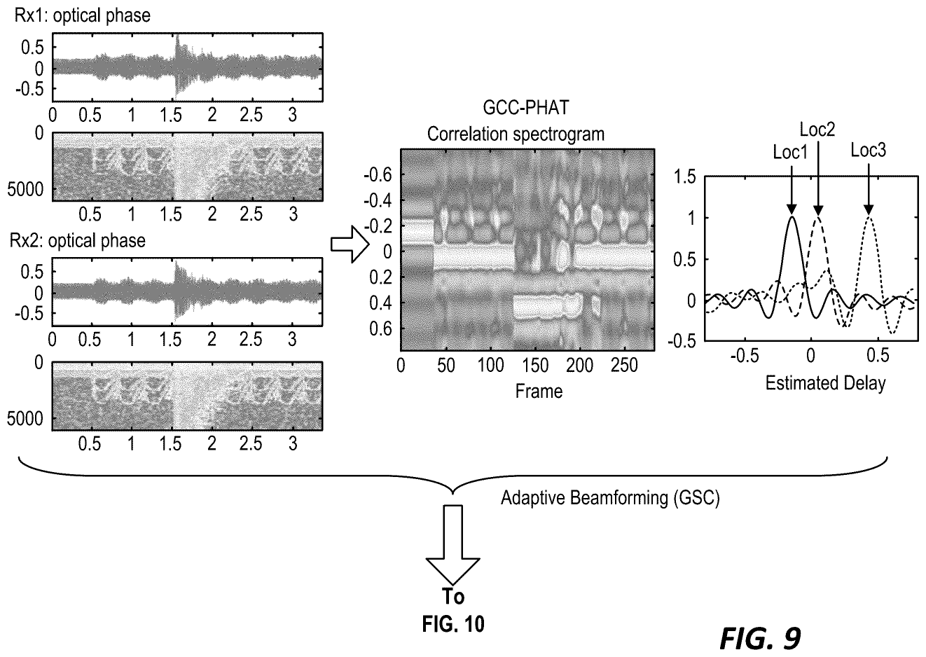

FIG. 9 shows the experimental results of the fiber stretcher in which Step 1 is the optical phase of Rx1 and Rx2, Step 2 is the correlation spectrogram from GCC-PHAT and the estimated location according to aspects of the present invention.

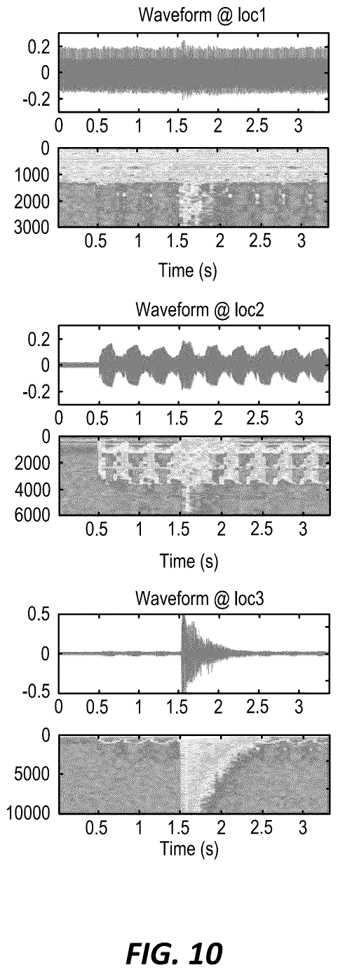

FIG. 10 shows the reconstructed waveforms at each location using the adaptive generalized sidelobe canceller (GSC) beamforming according to aspects of the present invention.

We select three types of signals which are common in the field (x1: transformer humming sound; x2: police siren; x3: gunshot) to apply to the fiber stretchers at 40 km, 60 km, and 100 km, respectively. The two Rx optical phases contain all these signals with additional noises, which is hard to distinguish and separate. Step 2 illustrates the normalized cross-correlation spectrogram obtained through GCC-PHAT with three clear correlation lines over time. It is noted that the gunshot has much stronger correlation due to the higher transient power and broader bandwidth. The locations are estimated as 40.022 km, 59.981 km, and 100.021 km, which matches the sensing fiber configuration. We use adaptive GSC beamforming which focuses on these three locations separately. Step 3 shows that the signal at the focus location are enhanced while the signal from other locations are effectively mitigated, with an SNR improvement of 10.1 dB, 10.3 dB, and 12.5 dB, respectively. These GSC beamforming results demonstrates a high-fidelity multi-event reconstruction for the distributed forwarding sensing

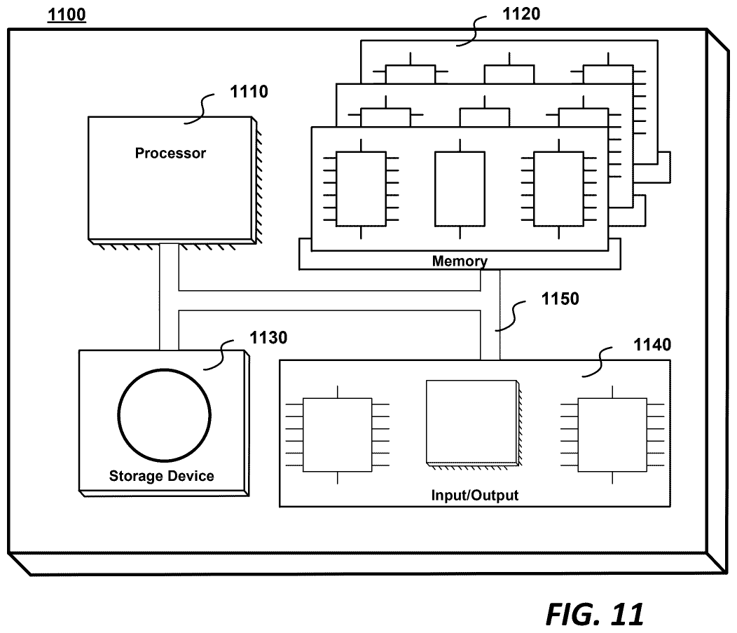

Finally, FIG. 11 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of several operating systems. The above-described methods of the present disclosure may be implemented on the computer system 1100 as stored program control instructions.

Computer system 1100 includes processor 1110, memory 1120, storage device 1130, and input/output structure 1140. One or more input/output devices may include a display. One or more busses 1150 typically interconnect the components, 1110, 1120, 1130, and 1140. Processor 1110 may be a single or multi core. Additionally, the system may include accelerators etc., further comprising a system on a chip.

Processor 1110 executes instructions in which embodiments of the present disclosure may comprise steps described in one or more of the Drawing figures. Such instructions may be stored in memory 1120 or storage device 1130. Data and/or information may be received and output using one or more input/output devices.

Memory 1120 may store data and may be a computer-readable medium, such as volatile or non-volatile memory. Storage device 1130 may provide storage for system 1100 including for example, the previously described methods. In various aspects, storage device 1130 may be a flash memory device, a disk drive, an optical disk device, or a tape device employing magnetic, optical, or other recording technologies.

Input/output structures 1140 may provide input/output operations for system 1100.

We have proposed an equivalent dual-sensor array model for the bi-directional forwarding sensing and demonstrated its improvement over 110 km fiber. Multiple events at three locations have been simultaneously monitored with GSC beamformer, showing improved the acoustic signal reconstruction, effective noise reduction, and interference mitigation from other locations. This opens new research directions such as null-steering, blind source separation, etc.

At this point, those skilled in the art will understand that while we have presented our inventive concepts and description using specific examples, our invention is not so limited. Accordingly, the scope of our invention should be considered in view of the following claims.

1. A computer-implemented method for multi-event distributed forward sensing and signal reconstruction, the method comprising:
receiving a first optical phase signal s₁(t) and a second optical phase signal s₂(t), the signals propagating bi-directionally over a sensing optical fiber of length L;
modeling the bi-directional distributed forwarding sensing as an equivalent dual-element sensor array (SA2), wherein an event location z along the fiber is mapped to a unique direction-of-arrival (DOA) angle α at the SA2;
transforming the received signals into a time-frequency domain using a Short-Time Fourier Transform (STFT);
localizing one or more events by applying Generalized Cross-Correlation with Phase Transform (GCC-PHAT) to the transformed signals to estimate a time shift Δτ for each event; and
reconstructing an acoustic waveform for a specific event location by applying a Generalized Sidelobe Canceller (GSC) adaptive beamforming technique, steered based on the estimated time shift Δτ, to enhance the signal at the specific event location and mitigate interference from other locations.

2. The method of claim 1, wherein the SA2 has an equivalent spacing of Ln_{eff}, where n_{eff} is the effective refractive index of the fiber.

3. The method of claim 1, wherein the mapping between the event location z and the DOA angle α is defined by the relationship:
$$α = arcsin ( \frac{L - 2 z}{L} ) .$$

4. The method of claim 1, wherein the step of reconstructing the acoustic waveform further comprises:
applying a pre-steering beamformer (P) to combine the transformed signals, thereby performing a delay-and-sum operation steered toward the specific event location;
applying a blocking matrix (B) to the transformed signals to generate a reference signal that blocks the signal from the specific event location while passing noise and interference; and
applying an adaptive canceller (H) to the reference signal, the adaptive canceller configured to minimize output power and cancel interference components prior to subtraction from the pre-steered signal.

5. The method of claim 4, further comprising applying a pre-filtering step before the GSC adaptive beamforming, the pre-filtering step including applying a time-frequency masking filter (M) to the transformed signals to select desired time and frequency components.

6. The method of claim 4, further comprising applying a post-filtering step to the output of the GSC adaptive beamformer to remove transient interference.

7. The method of claim 1, wherein the GSC adaptive beamforming technique enables simultaneous monitoring of multiple events and provides an SNR improvement of at least 10 dB for the reconstructed acoustic waveform.

8. A system for multi-event distributed forward sensing and high-fidelity signal reconstruction, comprising:
an optical fiber of length $L$ configured for bi-directional light wave propagation;
a first receiver (Rx1) and a second receiver (Rx2) configured to detect a first optical phase signal s₁(t) and a second optical phase signal s₂(t), respectively;
a processor configured to execute instructions including:
a time-frequency transform module configured to transform the optical phase signals into time-frequency domain data;
a localization module configured to apply Generalized Cross-Correlation with Phase Transform (GCC-PHAT) to the time-frequency data to estimate a time shift (Δτ) corresponding to an event location z; and
a reconstruction module configured to apply a Generalized Sidelobe Canceller (GSC) adaptive beamformer, steered based on the estimated Δτ, to reconstruct an acoustic waveform for the event location with enhanced signal-to-noise ratio.

9. The system of claim 8, wherein the GSC adaptive beamformer comprises a pre-steering beamformer, a blocking matrix, and an adaptive canceller.

10. The system of claim 8, wherein the processor is further configured to model the bi-directional forwarding sensing as an equivalent dual-element sensor array (SA2) with event locations mapped to direction-of-arrival angles.
